(19) United States
(12) Patent Application Publication
(10) Pub. No.: US 2026/0168320 A1
(43) Pub. Date: Jun. 18, 2026

(54) Structure of a roll-up door, particularly of the rapid sliding type

(71) Applicant: BMPEUROPE S.r.l., VILLANOVA d’ASTI (AT) (IT)

(72) Inventor: Danilo BENOTTO, Montá (CN) (IT)

(21) Appl. No.: 19/388,491

(22) Filed: Nov. 13, 2025

(30) Foreign Application Priority Data
Nov. 13, 2024 (IT) 102024000025566

(51) Int. Cl. E06B 9/58

(52) U.S. Cl. CPC E06B 9/581; E06B 2009/587

(57) ABSTRACT

A fast vertical sliding roller door includes a stationary portal structure mounted at the opening of a wall and comprising an upper cross-member and a pair of uprights made by hollow sections having a connecting plate for fixing to a side of the opening. A flexible closing element is slidably mounted along the uprights, whose longitudinal edges have projections slidingly mounted in a guide formation associated with a respective upright. One lateral face of each upright comprises at least one removable cover, the removal of which allows internal access to the upright, and is provided with a support profile having a pair of parallel flanges and an intermediate portion traversed by stems projecting from the guide formation. One flange has transverse slots for engagement of screws fixed along them by a nut, in order to adjust the transverse tension of the closing element.

### CROSS REFERENCE TO THE RELATED APPLICATION

The present application claims priority to Italian Patent Application Serial no. 102024000025566, filed Nov. 13, 2024, the contents of which are incorporated herein by reference.

### BACKGROUND OF THE INVENTION

The present invention relates in general to liftable closures, for example doors for industrial use, such as roll-up doors of the known so-called ‘fast vertical sliding’ type, in which the opening and closing phases take place at a relatively high speed.

In general, the liftable closures of the type mentioned above are associated with an opening of a wall delimited by a stationary portal structure defined by an upper crosspiece, by a pair of parallel and opposite vertical side uprights, and by a lower transverse plane. The portal structure furthermore comprises a closing element sliding along the vertical uprights, for example made by means of a flexible sheet of plastic material, normally PVC, polyethylene or polyurethane, which is movable between a closed configuration and an open configuration, respectively lowered and raised with respect to the lower transverse plane. Alternatively, the closing element may comprise a series of slats of various material arranged parallel and articulated to one another.

In the case of a sliding closing element in the form of a flexible sheet of plastic material, its opposite longitudinal edges are normally provided with a row of closely adjacent but mutually separated reliefs, which give to such edges substantially the form of a half-zip fastener, said reliefs slidingly engaging a pair of linear fork-shaped guide rails associated with a respective side upright in order to define the path of the closing element relative to the portal structure.

Each side upright of the portal structure has a generally rectangular cross-section, the face of which facing the opposite upright is provided with a recess within which a respective guide rail of one of the lateral edges of the flexible sheet is arranged.

Next to the upper crosspiece of the portal structure, for example above it, there is normally arranged a compartment for housing the closing element in its wound condition, corresponding to its raised configuration, which compartment is generally delimited by a parallelepiped-shaped box in which a motorized rotating shaft for winding the flexible sheet is usually mounted.

The structure of a roll-up door of the type defined above is known from document EP-3 187 680 A1, which concerns a wall of modular construction provided with a portal structure for a roll-up door. The uprights of the portal structure are constituted by sections that have a substantially rectangular closed cross-section, provided with a longitudinal cavity that accommodates a guide rail for the lateral edges of the flexible sheet and that is interposed between a pair of auxiliary recesses forming part of the same section and intended to receive accessory members of the sliding door, such as wirings or the like or sensor devices.

However, the fact that the uprights of this portal structure have a closed cross-section makes them not very versatile in use because it is relatively complex to access their interior, for example in the case of damage or maintenance of the upright, and it is for the most part not possible to replace parts of the damaged uprights, instead requiring the replacement of the entire upright.

Moreover, in a structure of the type defined above it is not very easy to finely adjust the transverse tension of the closing element when this is made by means of a flexible sheet.

### SUMMARY OF THE INVENTION

A purpose of the invention is to provide a roll-up door whose structure is highly versatile so as to allow access to the interior of its uprights, for example to replace damaged parts without the need to replace the entire uprights. Another purpose of the invention is to allow a fine adjustment of the transverse tension of the closing sheet in a simple and effective manner.

These purpose are achieved thanks to a roll-up door having the characteristics mentioned in the subject application.

In particular, thanks to the fact that each upright has a first lateral face relative to the respective connection plate which comprises at least one removable cover whose removal allows access to the interior of the upright, the structure of the roll-up door, in particular of its lateral uprights, proves to be simple and versatile, and allows access to its interior for prompt maintenance without requiring the replacement of the uprights or of parts thereof, as well as for finely adjusting the transverse tension of the closing sheet.

According to a preferred feature of the invention, each upright is provided with an internal support profile having a pair of parallel wings and an intermediate sheet-like part interposed between said wings, which is traversed by stems projecting from said guide formation, in which a first wing of said section has transverse slots for the engagement by shanks of screws engaged by a respective tightening nut for their fixing in a position relative to said slots, for the purpose of adjusting the position of the guide formation with respect to the respective upright and, with it, the transverse tension of said closing element.

According to another preferred feature of the invention, the stems projecting from said guide formation are directed towards said connection plate and are associated with elastic retaining means for the elastic retention of each guide formation to the respective support profile and to the respective upright. This allows any impacts undergone by the closing element to be progressively transmitted from the respective guide formation to the respective upright.

According to yet another preferred feature of the invention, said screws have a respective head accommodated with the possibility of sliding in an internal channel of the upright formed in a second lateral face of the upright parallel to said first lateral face.

According to a further preferred feature of the invention, the second wing of said support profile is arranged for the support of said at least one cover in its closed position, and is traversed by tightening screws of said at least one cover inserted on the upright from the outside. This makes it possible to provide an end-stop element for the closing movement of the at least one removable cover, which can be effectively closed in order to isolate the interior of the upright from the external environment.

According to yet a further preferred feature of the invention, the stems are tubular and said elastic retaining means comprise, for each stem, a coaxial helical spring and an adjustment screw engaged in an internal thread of the respective tubular stem. In this way, by acting on the adjustment screws from the interior of each upright, it is possible to adjust as desired the elastic tension applied by the edges of the flexible sheet in the various stretches of the guide rail.

### BRIEF DESCRIPTION OF THE DRAWINGS

Further features and advantages of the invention will become more clearly apparent from the detailed description that follows, provided by way of non-limiting example and referring to the appended drawings in which:

FIG. 1 is a schematic perspective view of a sliding door according to the invention with its closing element consisting of a flexible sheet in a partially open configuration,

FIG. 2 is an enlarged upper elevation view sectioned along line II-II of FIG. 1, which illustrates an upright of the sliding door in the closed configuration of use, mounted at a side of an opening of a wall, in order to constitute part of a portal structure,

FIG. 3 is a view similar to that of FIG. 2 with the upright in a partially open mounting configuration,

FIG. 4 is an upper elevation sectional and exploded view of a detail indicated by arrow IV in FIG. 3,

FIG. 5 is an enlarged perspective view of a length of a support profile of a guide formation of the closing sheet, made in the form of a section with C-shaped cross-section, and

FIG. 6 is a view similar to that of FIG. 3 with the upright in an open mounting condition and with some of its elements in an exploded configuration.

### DETAILED DESCRIPTION OF THE INVENTION

With reference to the figures, a roll-up door 10 of fast vertical sliding according to the invention comprises a portal structure 12 installed at a rectangular opening 14 formed in a wall W.

The structure 12 essentially has an upper crosspiece 16 and a pair of opposite vertical lateral uprights 18 one face of which consists of a connection plate 20 adapted to be fixed to a side 14a of the opening 14 by means of a series of screws 19.

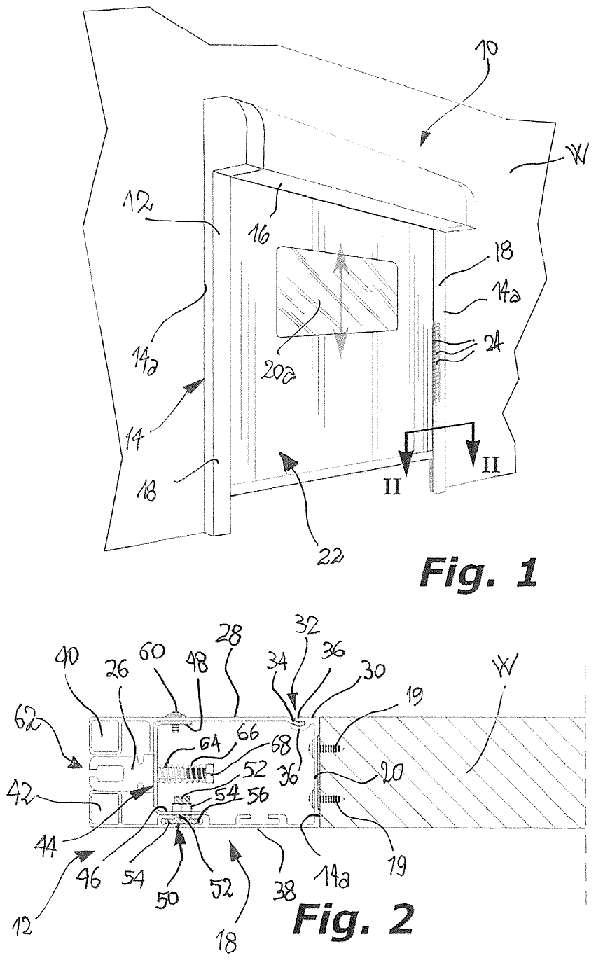

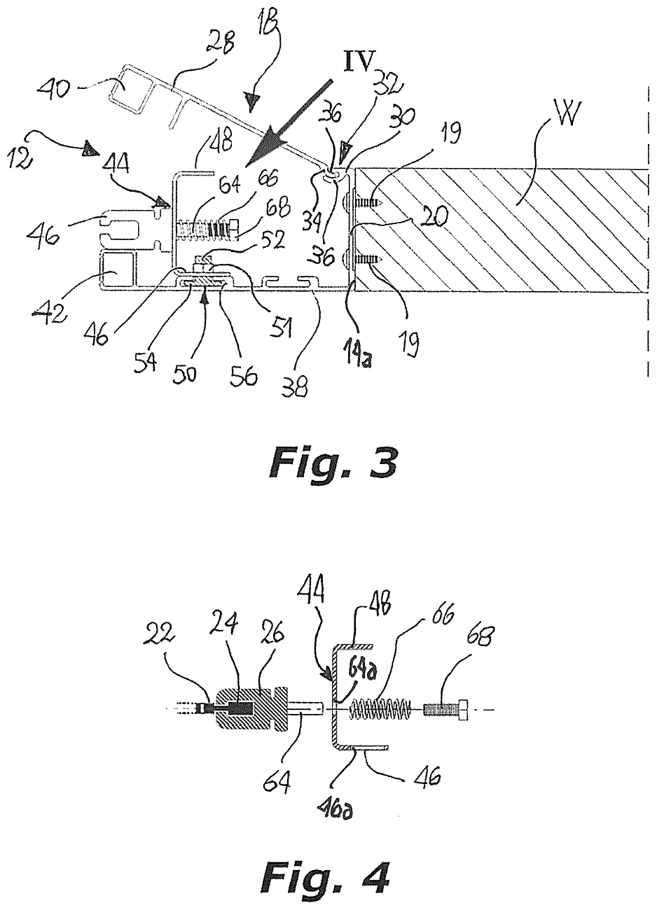

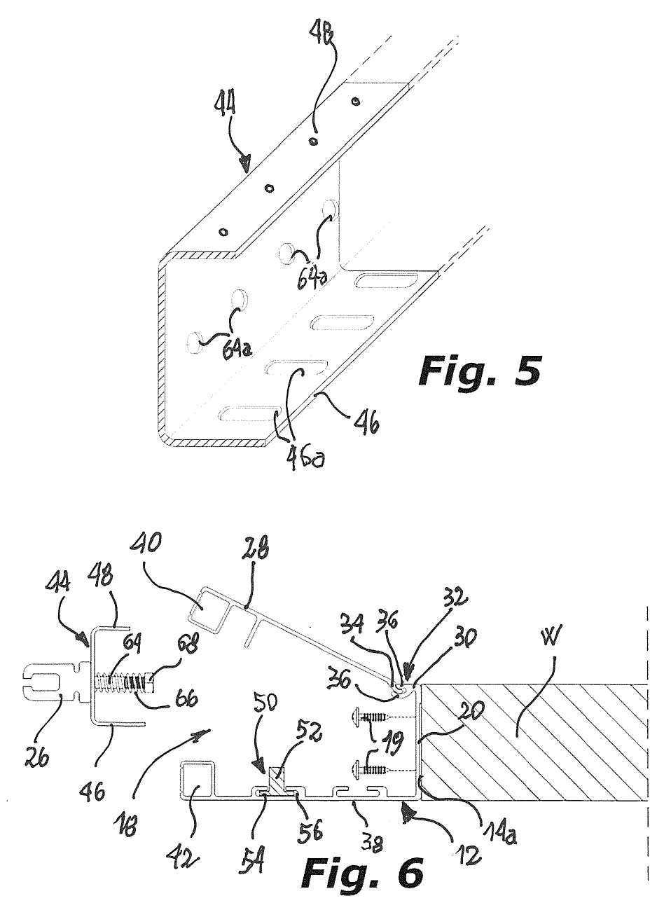

Between the uprights 18 a closing element 22 is mounted slidingly, whose longitudinal edges are provided with a series of reliefs 24 (see FIG. 1) closely adjacent and separated from one another, shaped substantially like the teeth of a zip fastener. These reliefs 24 slidingly engage respective rail-type guide formations 26 associated with the uprights 18, so that the closing element 22, thanks to the engagement of its lateral edges therein, can slide between a closed configuration and an open configuration, respectively lowered and raised, with respect to a transverse plane that delimits inferiorly the portal structure 12.

The flexible closing element 22 is usually made by means of a flexible sheet of plastic material, such as PVC, polyethylene or polyurethane, and may be provided with one or more windows 20a made by respective inserts of transparent flexible plastic material.

If the closing element 22 must also perform the function of a thermal barrier, it may include an intermediate insulating layer (not illustrated).

Moreover, the crosspiece 16 generally delimits a compartment arranged to house the closing element 22 in its raised configuration, which is usually wound, in a manner known per se, on a motorized rotating shaft (not illustrated in the figures) that extends parallel to the crosspiece 16.

Each upright 18 has a first lateral face 30 perpendicular to the respective connection plate 20, to which at least one removable cover 28 is associated, whose removal allows access to the interior of the upright 18.

In particular, at least one cover 28 is articulated to the first lateral face 30 by means of a linear hinge 32 whose axis extends in the longitudinal direction of the respective upright 18. Advantageously, this linear hinge 32 comprises a fork-shaped seat delimited on opposite sides by a pair of arcuate plates 36 that extend from the lateral face 30 of the upright 18, and an arcuate flap 34 projecting from one side of the at least one cover 28, which slidingly engages in the aforesaid fork-shaped seat.

Moreover, at least one cover 28 comprises, on the side opposite the connection plate 20, a first recess 40 for accommodating accessory elements that extend longitudinally with respect to the respective upright 18, such as wirings and/or sensor devices of a type known per se.

The upright 18, on the side opposite the cover 28, has a second stationary lateral face 38, substantially parallel to the first face 30, likewise provided with a recess 42 entirely analogous to the recess 40 on the side opposite the connection plate 20.

Each upright 18 is internally provided with a support profile 44 having a substantially C-shaped cross-section, which comprises a pair of parallel flanges 46 and 48. A first flange 46, of greater extension, has a series of transverse slots 46a in which respective shanks 52 of screws 50 engage, whose heads 54 are constrained within a channel 56 formed on the inner surface of the second lateral face 38 of the upright 18.

These shanks 52 are engaged, on the side opposite to the flange 46 with respect to the second lateral face 38 of the upright 18, by respective tightening nuts 54, so as to allow the screws 50 to be fixed in a selected position along the corresponding slots 46a, such as to cause the support profile 44 to assume a configuration in which a local tension is applied to the guide formation 26, capable of keeping the curtain 22 correctly taut in the transverse direction.

The second flange 48 of the support profile 44 forms a support surface against which at least one cover 28 bears in the closed configuration, and is crossed by locking screws 60 (see FIG. 2) inserted from the outside of the upright 18 onto the cover 28.

Between the first and the second recesses 40 and 42, a longitudinal cavity 62 is defined (see FIG. 2), in which the guide formation 26 is received, said guide formation being elastically connected to the support profile 44.

For this purpose, the guide formation 26 is provided with a series of projecting tubular stems 64 which engage through-holes 64a formed in the intermediate plate-like portion of the support profile 44 that extends between the wings 46 and 48, and which are directed inwardly of the upright 18 towards the connecting plate 20. Each of these stems 64 is furthermore associated with elastic retaining means so that any impacts received by the curtain 22 are progressively transmitted from the respective guide formation 26 to the corresponding support profile 44 and from this to the respective upright 18. In particular, said elastic retaining means include, for each tubular stem 64, a helical spring 66 arranged coaxially between said intermediate plate-like portion of the support profile 44 and the head of a screw 68 that engages an internal thread of the respective tubular stem 64.

In the operation of the sliding door of the invention, the uprights 18 are fixed at the sides 14a of the opening 14 of the wall W trough the screws 19, which can be associated with the connecting plate 20 of the respective upright 18 and operated so as to screw them in after removing the screws 60 and opening the at least one cover 28 following its rotation around the axis of the linear hinge 32.

The removal of the cover 28 also makes it possible to access the inside of the upright 18 in order to adjust the position of the assembly formed by the support profile 44 and the guide formation 26. For this purpose, the nuts 54 are loosened from the shanks 52 of the screws 50 and then tightened again at a preferred position of the shanks 52 along the respective slots 46a, so as to adjust the tension applied by the support profile 44 to the guide formation 26 and from it to the curtain 22, in order to regulate the transverse tension of the latter.

Moreover, it is possible to adjust the force exerted by the elastic retaining means associated with the stems 64 by screwing or unscrewing the screws 68 with respect to the threaded tubular stems 64, so as to locally vary the elastic force with which any impacts undergone by the curtain 22 are transmitted from the guide 26 formation to the respective upright 18.

If necessary, the assembly comprising the support profile 44 and/or the guide formation 26, and possibly the respective elastic means, can also be replaced.

1-12. (canceled)

13. A roller door, particularly of the fast vertical sliding type, comprising a stationary portal structure associated with an opening of a wall having two opposite longitudinal sides, said portal structure comprising an upper cross-member, a pair of vertical uprights, each of which is made by means of a respective hollow section comprising a connecting plate intended to be fixed to a respective side of the opening, as well as a flexible closing element slidably mounted along said uprights, each longitudinal edge of the closing element having a series of projections that slidably engage a guide formation associated with a respective upright, wherein each upright has a first lateral face facing the respective connecting plate, which comprises at least one removable cover whose removal allows access to the interior of the upright.

14. The roller door according to claim 13, wherein said closing element is a flexible curtain, and in that said projections of its longitudinal edges are closely adjacent and mutually spaced, being shaped substantially like the teeth of a zipper.

15. The roller door according to claim 14, wherein each upright is provided with an internal support profile having a pair of parallel flanges and an intermediate sheet-like portion interposed between said flanges, which is traversed by stems projecting from said guide formation, wherein a first flange of said section has transverse slots for engagement by shanks of screws engaged by a respective tightening nut for their fixing in a position relative to said slots, for the purpose of adjusting the position of the guide formation with respect to the corresponding upright and, with it, the transverse tension of said closing element.

16. The roller door according to claim 15, wherein said stems projecting from said guide formation are directed towards said connection plate and are associated with elastic retaining device for the elastic retention of each guide formation to the respective support section and to the corresponding upright.

17. The roller door according to claim 15, wherein said screws have a respective head received with sliding capability in an internal channel of the upright, formed in a second lateral face of the upright parallel to said first lateral face.

18. The roller door according to claim 15, wherein the second flange of said support profile is configured to provide a bearing surface for said at least one cover in its closed position, and in that it is traversed by tightening screws of said at least one cover, inserted into the upright from the outside.

19. The roller door according to claim 15, wherein said stems are tubular and said elastic retaining device comprise, for each stem, a coaxial helical spring and an adjustment screw engaged in an internal thread of the respective tubular stem.

20. The roller door according to claim 13, wherein said at least one removable cover is articulated to the respective upright trough a linear hinge whose axis extends in the longitudinal direction of the respective upright.

21. The roller door according to claim 20, wherein said linear hinge comprises a pair of arcuate plates that extend from said first lateral face of said upright and form a fork-shaped seat slidably engaged by an arcuate flap projecting from said at least one cover.

22. The roller door according to claim 20, wherein said at least one cover comprises, on the side opposite said connecting plate, a first recess for accommodating accessory elements that extend longitudinally with respect to the respective upright.

23. The roller door according to claim 20, wherein said second lateral face comprises, on the side opposite said connecting plate, a second recess for accommodating accessory elements that extend longitudinally with respect to the respective upright.

24. The roller door according to claim 22, wherein between said first and second recesses, on the side opposite said connecting plate, there is interposed a longitudinal cavity for receiving said guide formation associated with each upright.

25. The roller door according to claim 16, wherein said screws have a respective head received with sliding capability in an internal channel of the upright, formed in a second lateral face of the upright parallel to said first lateral face.

26. The roller door according to claim 16, wherein the second flange of said support profile is configured to provide a bearing surface for said at least one cover in its closed position, and in that it is traversed by tightening screws of said at least one cover, inserted into the upright from the outside.

27. The roller door according to claim 16, wherein said stems are tubular and said elastic retaining device comprise, for each stem, a coaxial helical spring and an adjustment screw engaged in an internal thread of the respective tubular stem.

28. The roller door according to claim 14, wherein said at least one removable cover is articulated to the respective upright trough a linear hinge whose axis extends in the longitudinal direction of the respective upright.

29. The roller door according to claim 17, wherein the second flange of said support profile is configured to provide a bearing surface for said at least one cover in its closed position, and in that it is traversed by tightening screws of said at least one cover, inserted into the upright from the outside.

30. The roller door according to claim 17, wherein said stems are tubular and said elastic retaining device comprise, for each stem, a coaxial helical spring and an adjustment screw engaged in an internal thread of the respective tubular stem.

31. The roller door according to claim 15, wherein said at least one removable cover is articulated to the respective upright trough a linear hinge whose axis extends in the longitudinal direction of the respective upright.
